(19) United States
(12) Patent Application Publication
(10) Pub. No.: US 2025/0355790 A1
(43) Pub. Date: Nov. 20, 2025

(54) Converting a Request for Quote into a Specification for a Test System

(71) Applicant: NATIONAL INSTRUMENTS CORPORATION, Austin, TX (US)

(72) Inventors: Andrew Philip Dove, Austin, TX (US); Stephen Thung, Norman, OK (US); Sebastien Savard-Rosas, Austin, TX (US)

(21) Appl. No.: 19/211,004

(22) Filed: May 16, 2025

Related U.S. Application Data
(60) Provisional application No. 63/648,900, filed on May 17, 2024.

(51) Int. Cl. G06F 11/3668; G06F 11/3698

(52) U.S. Cl. CPC G06F 11/3696; G06F 11/3698

(57) ABSTRACT

Apparatuses, systems, and methods for generative Artificial Intelligence (AI)/Large Language Model (LMM) assisted test system specification based on an initial input of a request for quote (RFQ) or request for information (RFI). An RFQ/RFI document can be provided as input to the AI/LLM model. The AI/LLM model can also receive selection and detection criteria and user-provided input associated with the RFQ/RFI document as guidance for the generative AI/LLM process. The AI/LLM model generate a test system specification from the RFQ/RFI document, with the test system specification fulfilling one or more criteria identified from the RFQ/RFI document.

### PRIORITY CLAIM

This application claims benefit of priority to provisional application No. 63/648,900 entitled “Converting a Request for Quote into a Specification for a Test System”, filed on May 17, 2024, whose disclosure is hereby incorporated by reference in its entirety as though fully and completely set forth herein.

### TECHNICAL FIELD

The invention relates to test process development, and more particularly to apparatuses, systems, and methods for generative Artificial Intelligence (AI) assisted test process development, e.g., using a generative AI based system to convert a request for quote into a specification for a battery lab validation system.

### DESCRIPTION OF THE RELATED ART

Currently, there are a variety of tools to support a test engineer in test process development when given a specification of a DUT. For example, there are tools to aid a test engineer in the front-end of life cycle of a test process, e.g., such as tools to match tests to instruments. Further, there are tools to aid a test engineer in the back-end of the life cycle of the test process, e.g., such as tools that provide measurement abstraction. In addition, there are various tools that provide high-level test support as well as tools that can generate test sequences based on detailed inputs from the test engineer.

However, a test engineer may need to work/interact with many, disparate software systems to leverage these various tools to develop a specification for a test system, and the test process(s) for a device under test (DUT) in that system. For example, in various aspects of development of the test system and process, a test engineer may have the role of a design engineer (e.g., during design of the DUT and/or development of tests and test facilities can be used to validate the design of the DUT as well as during design of tests than can be reused across the test life cycle of the DUT), test architect (e.g., during design of test systems and identification of reusable components for tests), validation engineer (e.g., during characterization and validation of DUTs), and/or production test engineer (e.g., during development of tests that monitor production processes as well as yield of production DUTs). Each role/tool may require its own expertise and resource, leading to high overhead costs in time, training, and expertise develop. These high overhead costs may then extend time to market for particular products. Therefore, improvements are desirable.

### SUMMARY

Embodiments described herein relate to computing systems, memory media, and methods for generative Artificial Intelligence (AI) assisted development of test system specification(s), e.g., using a generative AI based system to produce a specification for a test system, e.g. based on an initial input of a request for quote or request for information.

For example, a request for quote for a test system may be inputted (e.g., using various formats such as word processing documents and Portable Document Format (PDF) documents, among other file types and/or formats) into a Generative AI model, or Large Language Model (LLM) based generative system. The Generative AI model or LLM system may then summarize the documents and request further input via a question/answer interaction with an end user to finalize a description of the test system specification based on the documents. Further, the Generative AI model or LLM system may query (e.g., via an interactive question/answer session) the end user regarding possible options to develop a test system specification. The Generative AI model or LLM system may then generate/create, e.g., based on the description and/or information provided in the request (for quote or information) document and the interactions with the end user, various assets, such as code, documentation, tables, diagrams, and so forth. The Generative AI model or LLM system may collaborate with the end user to refine outputs from the test system specification.

In some embodiments, the generative AI may be interacted with via a user interface such as a local application running on a given device or a web-based application/program or the like in which documents (e.g., word processing documents, Portable Document Format (PDF) documents, etc.) can be directly “dropped” into the application for the generative AI or LLM system to consume. In addition, the generative AI or LLM system may display, e.g., via the application user interface, questions, interactions, generated modules, system components, etc. as part of a proposal generated for a test system specification based on the inputted request for quote or request for information document.

Note that the techniques described herein may be implemented in and/or used with a number of different types of devices, including but not limited to cellular phones, tablet computers, wearable computing devices, portable computing devices, portable media players, and any of various other computing devices.

This Summary is intended to provide a brief overview of some of the subject matter described in this document. Accordingly, it will be appreciated that the above-described features are only examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the disclosed embodiments can be obtained when the following detailed description of the preferred embodiments is considered in conjunction with the following drawings.

FIG. 1 illustrates an example of a computer system, according to some embodiments.

FIG. 2 illustrates an example block diagram of a server 104, according to some embodiments.

FIG. 3 illustrates an example of a system supporting a specification to test platform, according to some embodiments.

FIG. 4 illustrates a block diagram of an example of a method for artificial intelligence (AI)/Large Language Model (LLM) aided parsing of an input document, according to some embodiments.

FIG. 5 illustrates a block diagram of an example of a method for artificial intelligence (AI)/Large Language Model (LLM) aided extraction of requirements from one or more input documents, according to some embodiments.

FIG. 6 illustrates a block diagram of an example of a method for artificial intelligence (AI)/Large Language Model (LLM) aided check for compliance of extracted requirements from one or more input documents, according to some embodiments.

FIG. 7 illustrates a block diagram of an example of a method for artificial intelligence (AI)/Large Language Model (LLM) aided association of extracted requirements from one or more input documents with a device category, according to some embodiments.

FIG. 8 illustrates a block diagram of an example of a method for artificial intelligence (AI)/Large Language Model (LLM) aided association of device category descriptors to extracted requirements, according to some embodiments.

FIG. 9 illustrates a block diagram of an example of a method for artificial intelligence (AI)/Large Language Model (LLM) aided generation of a test system specification, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
AI: Artificial Intelligence
DUT: Device Under Test
UUT: Unit Under Test
VI: Virtual Instrument
GUI: Graphical User Interface
LLM: Large Language Model

### Terms

The following is a glossary of terms used in this disclosure:

Device Under Test (DUT) or Unit Under Test (UUT)—A physical device or component that is being tested.

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element-includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Program—the term “program” is intended to have the full breadth of its ordinary meaning. The term “program” includes 1) a software program which may be stored in a memory and is executable by a processor or 2) a hardware configuration program useable for configuring a programmable hardware element.

Software Program—the term “software program” is intended to have the full breadth of its ordinary meaning, and includes any type of program instructions, code, script and/or data, or combinations thereof, that may be stored in a memory medium and executed by a processor. Exemplary software programs include programs written in text-based programming languages, such as C, C++, Pascal, Fortran, Cobol, Java, assembly language, etc.; graphical programs (programs written in graphical programming languages); assembly language programs; programs that have been compiled to machine language; scripts; and other types of executable software. A software program may comprise two or more software programs that interoperate in some manner.

Hardware Configuration Program—a program, e.g., a netlist or bit file, that can be used to program or configure a programmable hardware element.

Graphical Program—A program comprising a plurality of interconnected nodes or icons, where the plurality of interconnected nodes or icons visually indicate functionality of the program. May also be referred to as a Virtual Instrument (VI).

Data Flow Graphical Program (or Data Flow Diagram)—A graphical program or diagram comprising a plurality of interconnected nodes, wherein the connections between the nodes indicate that data produced by one node is used by another node. May also be referred to as a Virtual Instrument (VI).

Graphical User Interface—this term is intended to have the full breadth of its ordinary meaning. The term “graphical user interface” is often abbreviated to “GUI”. A GUI may comprise only one or more input GUI elements, only one or more output GUI elements, or both input and output GUI elements. May also be referred to as a Virtual Instrument (VI).

The following provides examples of various aspects of GUIs. The following examples and discussion are not intended to limit the ordinary meaning of GUI, but rather provide examples of what the term “graphical user interface” encompasses:

A GUI may comprise a single window, panel, or dialog box having one or more GUI Elements, or may comprise a plurality of individual GUI Elements (or individual windows each having one or more GUI Elements), wherein the individual GUI Elements or windows may optionally be tiled together.

Graphical User Interface Element—an element of a graphical user interface, such as for providing input or displaying output. Exemplary graphical user interface elements include input controls and output indicators.

Input Control—a graphical user interface element for providing user input to a program. Exemplary input controls include buttons, check boxes, input text boxes, knobs, sliders, etc.

Output Indicator—a graphical user interface element for displaying output from a program. Exemplary output indicators include charts, graphs, gauges, output text boxes, numeric displays, etc. An output indicator is sometimes referred to as an “output control”.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

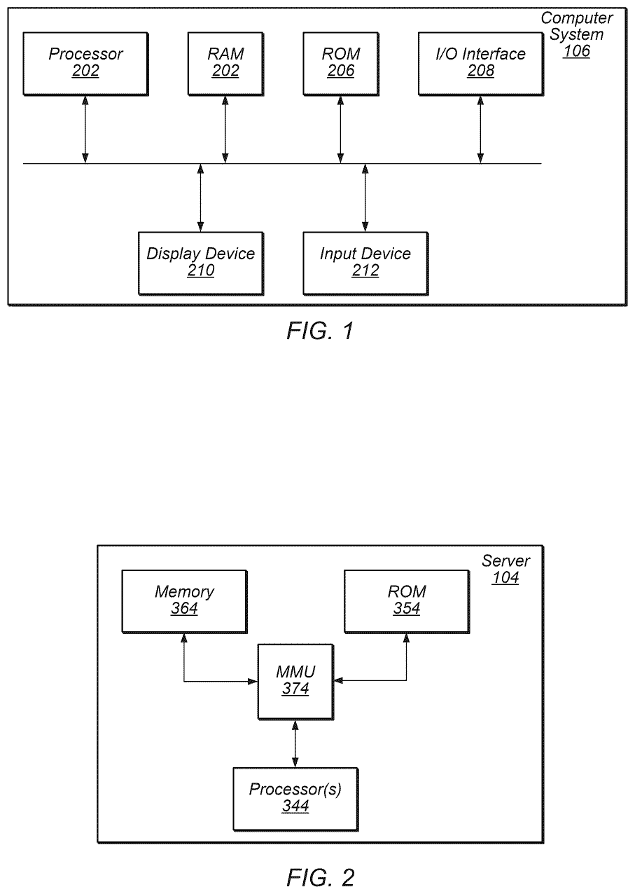

### FIG. 1: Computer System

FIG. 1 illustrates a computer system 106 that may include a processor 202, random access memory (RAM) 204, nonvolatile memory 206, a display device 210, an input device 212 and an I/O interface 208 for coupling to sensors. For example, the computer system 106 may include hardware and software components for implementing or supporting implementation of features described herein. The processor 202 may be configured to implement or support implementation of part or all of the methods described herein, e.g., by executing program instructions stored on a memory medium (e.g., a non-transitory computer-readable memory medium). Alternatively, the processor 202 may be configured as a programmable hardware element, such as an FPGA (Field Programmable Gate Array), or as an ASIC (Application Specific Integrated Circuit), or a combination thereof. Alternatively (or in addition) the processor 202, in conjunction with one or more of the other components 204, 206, 208, 210, and/or 212 may be configured to implement or support implementation of part or all of the features described herein.

In addition, as described herein, processor(s) 202 may be comprised of one or more processing elements. In other words, one or more processing elements may be included in processor(s) 202. Thus, processor(s) 202 may include one or more integrated circuits (ICs) that are configured to perform the functions of processor(s) 202. In addition, each integrated circuit may include circuitry (e.g., first circuitry, second circuitry, etc.) configured to perform the functions of processor(s) 202.

As shown, the computer system 106 may include a processor that is coupled to a random access memory (RAM) and a nonvolatile memory. The computer system 106 may also include user interface elements for receiving user input and a display device for presenting output. For example, the user interface elements may include any of various elements, such as a display (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input. The computer system 106 may also include an Input/Output (I/O) interface that may be communicatively coupled (e.g., locally via a system bus, or remotely via a network and/or serial interface) to various hardware elements (e.g., such as FPGAs, data acquisition boards, controllers, and the like).

### FIG. 2: Server

FIG. 2 illustrates an example block diagram of a server 104, according to some embodiments. It is noted that the server of FIG. 2 is merely one example of a possible server. As shown, the server 104 may include processor(s) 344 which may execute program instructions for the server 104. The processor(s) 344 may also be coupled to memory management unit (MMU) 374, which may be configured to receive addresses from the processor(s) 344 and translate those addresses to locations in memory (e.g., memory 364 and read only memory (ROM) 354) or to other circuits or devices.

The server 104 may be configured to provide a plurality of devices, such as computer system 106, access to a generative AI, e.g., as further described herein.

In some embodiments, the server 104 may access via a radio access network, such as a 5G New Radio (5G NR) radio access network. In some embodiments, the server 104 may be access via a local area network (LAN), e.g., via an ethernet and/or Wi-Fi connection.

As described further subsequently herein, the server 104 may include hardware and software components for implementing or supporting implementation of features described herein. The processor 344 of the server 104 may be configured to implement or support implementation of part or all of the methods described herein, e.g., by executing program instructions stored on a memory medium (e.g., a non-transitory computer-readable memory medium). Alternatively, the processor 344 may be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 may be configured to implement or support implementation of part or all of the features described herein.

In addition, as described herein, processor(s) 344 may be comprised of one or more processing elements. In other words, one or more processing elements may be included in processor(s) 344. Thus, processor(s) 344 may include one or more integrated circuits (ICs) that are configured to perform the functions of processor(s) 344. In addition, each integrated circuit may include circuitry (e.g., first circuitry, second circuitry, etc.) configured to perform the functions of processor(s) 344.

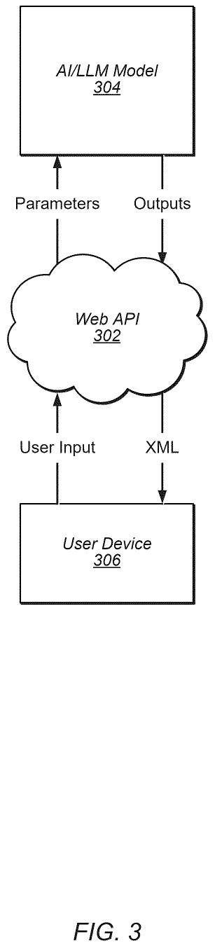

### FIG. 3: System for Supporting a Test Generation System

FIG. 3 illustrates an example of a system for supporting a test generation system, according to some embodiments. As shown, the system may include a user device 306, e.g., which may be a computer system 106 that provides an interface with an AI/LLM model 304 (e.g., which may be hosted on a server, such as server 104) via a web Application Programming Interface (API) 302. The interface may allow the AI/LLM model 304 to interact with (e.g., communicate with) local hardware either on the user device 306 and/or in communication with the user device 306. In addition, the interface may allow the AI/LLM model 304 to interact with local software resources (e.g., such as programming platforms (e.g., LabVIEW™, Python, MeasurementLink, C++, MATLAB™, and so forth). Thus, as shown, a user may interact with the AI/LLM model 304 via web API 302 using the user device 306. The user device 306 may execute one or more software resources as well as host hardware (e.g., such as data acquisition boards, control boards, vision boards, and the like) and/or communicate with remote hardware (e.g., such as data acquisition boards, control boards, vision boards, and the like). The user device 306 may provide user inputs, including information regarding available hardware and/or software resources to the web API 302. The web API 302 may convert the user inputs to AI/LLM model parameters and/or the web API 302 may generate AI/LLM model parameters based on the user inputs. The AI/LLM model parameters may be used by the AI/LLM model 304 to generate and/or produce model outputs that are returned to the web API 302. The web API 302 may then convert the model outputs to Extensible Markup Language (XML) and/or generate XML based on the model outputs. For example, the model outputs may include programming code (e.g., such as graphical programming code) that may be converted (e.g., serialized) to Large Language Model (LLM) optimized XML, JavaScript Object Notation (JSON), and/or a Domain Specific Language (DSL). The XML may then be delivered to the user device 306 as natural language output to an end user. In this manner, the AI/LLM model 304 may interact with the end user to generate and/extract test requirements from documentation associated with a device under test (DUT). Note that the AI/LLM model 304 may be trained to query end users using a plurality of prompts based on user input. Further, the AI/LLM model 304 may be trained to generate graphical programs based on consuming graphical programs, e.g., the AI/LLM model 304 may be trained using thousands of graphical programs. Note further, that aspects of the AI/LLM model 304 may include a user interface executing on the user device 306 as well as background software to discover and maintain hardware information as well as to discover and maintain connections with local applications, the web API 302 to allow the user device 306 to interact with the AI/LLM model 304, and the AI/LLM model 304 that may be executing on a server remote from the user (e.g., the AI/LLM model 304 may be cloud based).

### From Request for Quote to Test System Specification

Embodiments described herein provide systems, methods, and mechanisms for generative Artificial Intelligence (AI) assisted test system specification, e.g., using a generative AI based system, e.g. via use of a Large Language Model (LLM) system to produce test system specifications based on an initial input of a request for quote (for example, a request for a quote for establishing a test system. Furthermore, such test system specifications may further be inputted into the AI, or LLM, generative system for obtaining corresponding tests/test procedures, for example as described in U.S. Provisional Patent Application No. ______, which is hereby incorporated by reference as though fully and completely set forth herein. For example, a request for quote for a test system may be inputted (e.g., using various formats such as word processing documents, Portable Document Format (PDF) documents, or other similar document formats) into a Generative AI model, e.g. such as AI/LLM model 304, executing on a computer system, such as computer system 106, and/or a server, such as server 104. The Generative AI, or LLM-based, model may summarize (e.g., consume, process, and/or analyze) the documents and request further input via a question/answer interaction with an end user to finalize a description of the request, based on the documents. Further, the Generative AI, or LLM-based, model may query (e.g., via an interactive question/answer session) the end user regarding possible options to develop a test system specification. For example, the generative AI/LLM may query the end user to clarify what the end user meant. In other words, the generative AI/LLM may not only provide options, but also ask for clarification from the end user on specification options. The Generative AI/LLM model may then generate/create, e.g., based on the request for quote and/or information and the interactions with the end user, various aspects of a test system specification. The Generative AI model may collaborate with (e.g., interact with and/or guide) the end user to refine outputs from the generative AI/LLM.

In some instances, the generative AI may be interacted with via a user interface such as a local application running on a given device or a web-based application/program or the like in which documents (e.g., word processing documents, Portable Document Format (PDF) documents, etc.) can be directly “dropped” into the application for the generative AI or LLM system to consume. In addition, the generative AI or LLM system may display, e.g., via the application user interface, questions, interactions, generated modules, system components, etc. as part of a proposal generated for a test system specification based on the inputted request for quote or request for information document.

In some instances, the Generative AI model may guide a user from request for quote/information to specification to test. For example, the Generative AI/LLM model may aid and/or develop a test system specification based on the request, then develop a test plan based on the specification, including a DUT specification, a list of required hardware, and channel configurations, etc. In addition, the Generative AI/LLM model may generate programming code, e.g., based on LabVIEW™, Python, MeasurementLink, C++, MATLAB™, and so forth. Further, the Generative AI/LLM model may generate TestStand™ sequences, general test sequences, operator manuals, calibration codes and/or intervals, and so forth. In this manner, the Generative AI/LLM model may support a request for quote/information to test system and/or test specification to test (Request to Test) platform. Additionally, the Generative AI/LLM model may produce and/or generate all assets needed to run, deploy, debug, and/or maintain a test system and corresponding tests.

In some instances, algorithms described herein can enable an application that can use an LLM (or LLM system) to analyze documents and generate content from the analyzed documents. The forms the analysis can take can be based on prompt engineering and retrieval augmentation.

In some instances, the algorithms described here can be designed to compensate for poor performance and quota limits inherent in current LLMs. Note that while it is possible that as LLMs improve some of the algorithms described herein may no longer be useful, there is almost always a scale larger than the preceding one that the algorithms described herein can help solve.

In some instances, models can be subject to constraints to make them runnable on available cloud hardware. For example, there can be different tiers of service, e.g., a lowest tier may include models that are shared by multiple users and have quota limits that can be low enough that they are easily hit during normal usage. In addition, there can also be content filters designed to remove offensive language, triggered by words commonly used in engineering such as “execute”. Accordingly, algorithms can feature “rate limit” and “filter” exceptions that represent issues not intrinsic to the models themselves.

In some instances, a summarization prompt, e.g., such as “Provide a summary of the following text\nTEXT:{text}” can be used to provide background information as well as custom instructions to obtain a satisfactory summarization. Note that such a prompt can be adjusted for brevity/verbosity as well as any number of objectives.

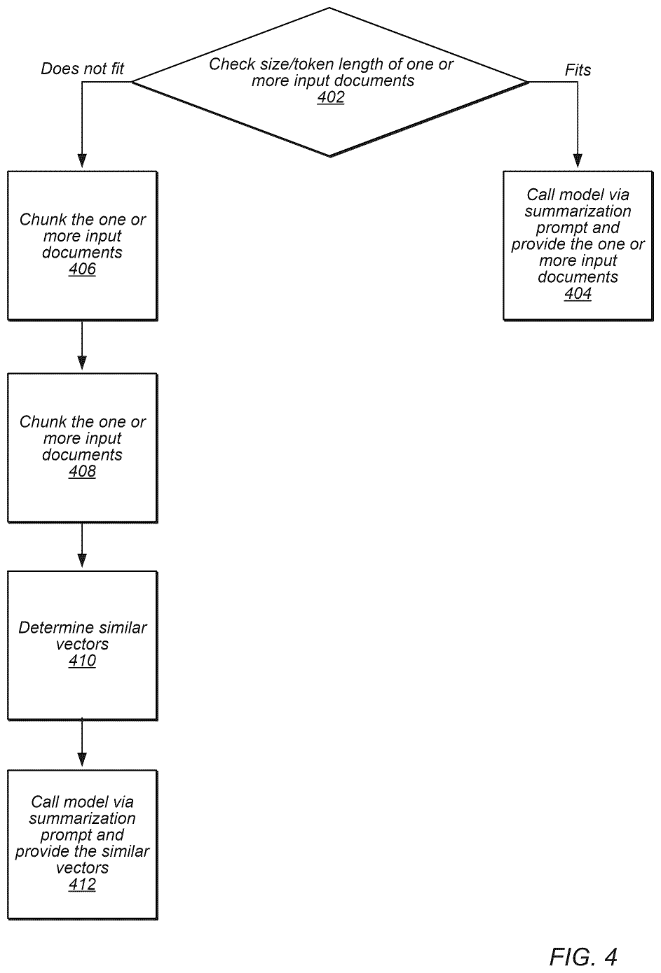

In some instances, portions of an input document (e.g., such as a request for quote/information) can be identified as representing most of the “meaning” of the input document and a summary can be created and/or generated based on these portions of the input document, e.g., a representative vector can be generated. For example, in some instances, an algorithm for parsing an input document can included the following aspects, e.g., as illustrated by FIG. 4. Note that FIG. 4 illustrates a block diagram of an example of a method for artificial intelligence (AI)/Large Language Model (LLM) aided parsing of an input document, according to some embodiments. The method shown in FIG. 4 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 402, a size and/or token length of one or more input documents can be checked.

At 404, if and/or when the size and/or token length of the one or more input documents fits within a context of a model (e.g., with room for enough output tokens), the model can be called with the above mentioned summarization prompt and the entirety of the one or more input documents.

At 406, if and/or when the one or more input documents are too large and do not fit within a context of the model, text of the one or more documents can be split and/or parsed into relatively large chunks.

At 408, the relatively large chunks can be embed to obtain corresponding vectors. Note that this can be performed beforehand as a preprocess step at least in some instances.

At 410, a, K-means clustering of the corresponding vectors can be performed to determine which corresponding vectors are similar to each other, implying that these similar vectors likely reference the same parts of the one or more input documents. Note that K may be selected depending on the model's maximum context size and how large each chunk is on average.

At 412, vectors (or embeddings) that represent each cluster the most (e.g., closest to each cluster centroid) can be selected and summarized and the model can be called with the above mentioned summarization prompt and the vectors that represent each cluster the most.

In some instances, a chat history with an LLM, such as LLM 304, can start empty. In other instances, a chat history and a new question can be used to create a “standalone question”. Then, the standalone question can be passed into a retrieval step to fetch relevant input documents. Note that if only a new question was passed in, then relevant context may be lacking and, conversely, if an entire chat history (e.g., conversation) is passed into retrieval, there may be unnecessary information there can distract from retrieval. Thus, a prompt can be provided to offer an opportunity to condense the question. For example, the standalone question can be embedded and used to perform a similarity search over contents of a vector database. Further, a filter can be applied to determine which collections to search within the vector database, e.g., objects in the database can be conditionally filtered based on metadata. Then, a similarity score (e.g., calculated by dot product) threshold may be set as well as a maximum cap on a number of retrieved objects may be set. The retrieved documents can then be passed to an LLM, e.g., such as LLM 304, along with the standalone question. In addition and/or alternatively, the original question and chat history can be passed to the LLM. The LLM can then generate a final response. Note that although the standalone question may be used, passing the chat history and the original question to the LLM may be preferred at least in some instances, e.g., such as when there is sufficient token space in the LLM. Note further that a prompt for the question may provide some additional context and guidance just as the above mentioned summarization prompt does. The LLM can then return an answer to the user and append the original question and answer to a chat history data structure.

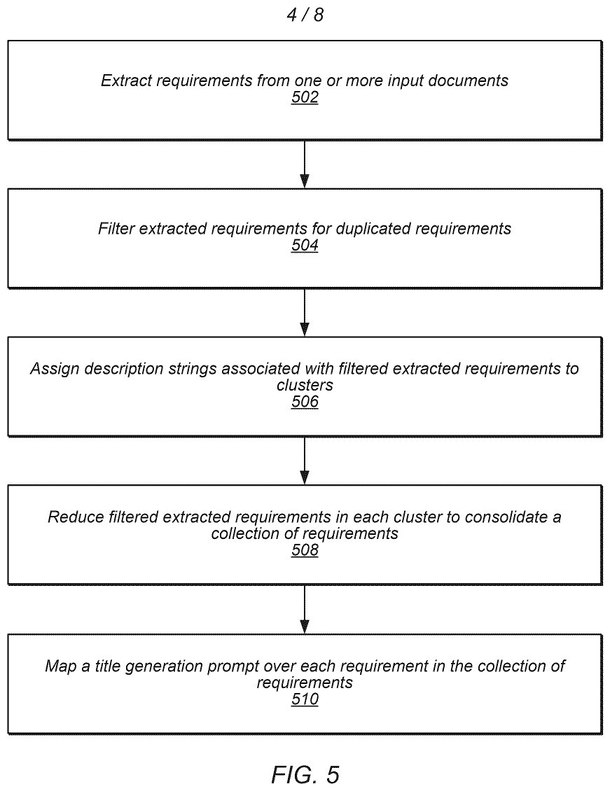

FIG. 5 illustrates a block diagram of an example of a method for artificial intelligence (AI)/Large Language Model (LLM) aided extraction of requirements from one or more input documents, according to some embodiments. The method shown in FIG. 5 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 502, requirements can be extracted (e.g., a string description of the requirement as well as a categorization of the requirement e.g. hardware, software, documentation, other) from one or more input documents. In some instances, each page of the one or more input documents can be iterated over and an LLM, such as LLM 304, can be called via a prompt template. The prompt template can provide specific instructions on how to extract requirements given the one or more input documents as well as instructions on how to output the requirements in a structured JSON string format. In some instances, a Langchain's Pydantic output parser can be used to generate the output format instructions. In addition, as pages of the one or more input documents are iterated through, metadata for each extracted requirement can be tracked. Note that the metadata can include information such as source (e.g., filename) and page number used for an extracted requirement. Note further that LLM calls can be done in parallel, at least in some instances. Note that in at least some instances, one benefit of running requirement extraction on a page-by-page basis can be built-in awareness of a location of a requirement, e.g., the location of the requirement can be obtained. Further, in some instances, a number of LLM calls and tokens used can be reduced by extracting requirements on more than one page at a time, possibly keeping track of the requirements' locations as metadata as well.

At 504, after requirements extraction, a quick filtering may be performed for extracted requirements that have a same or extremely similar description string (or vector). This can occur when extracted requirements are mentioned more than once in the one or more input documents. In some instances, a Boolean ‘reduced’ attribute may be set in the requirement's metadata to true. In some instances, a string description of each requirement may be embedded and held onto a vector (e.g., embedded) in meta data associated with the extracted requirements. Note that extremely similar requirements may be considered extracted requirements whose description strings (or vectors) have a similarity score that passes a specific threshold, e.g., a threshold of 0.99 or 0.90 and the like. In other words, similarity scores can be used to target duplicated extracted requirements rather than extracted requirements that are very similar (e.g., similarity scores are close to, but less than the specific threshold). Note that a similarity score can be the dot product of two vectors.

At 506, each requirement description string (or vector) can be assigned to a cluster. First, UMAP can be used as an effective preprocessing step to boost the performance of density-based clustering, which reduces a dimensionality of high dimensionality embeddings. HBDSCAN (a hierarchical clustering algorithm) can then be used to assign each requirement description string to clusters of similar requirement description strings. This cluster label can be held in the requirement's metadata object.

At 508, requirements in each cluster of similar requirements can be reduced into a more consolidated collection of requirements. A corresponding reduce prompt can be mapped over each cluster of requirements in parallel. At 510, a title generation prompt may be mapped over each of the requirements in parallel. The title in the requirement's metadata object can be retained. Thus, the requirements have now been extracted.

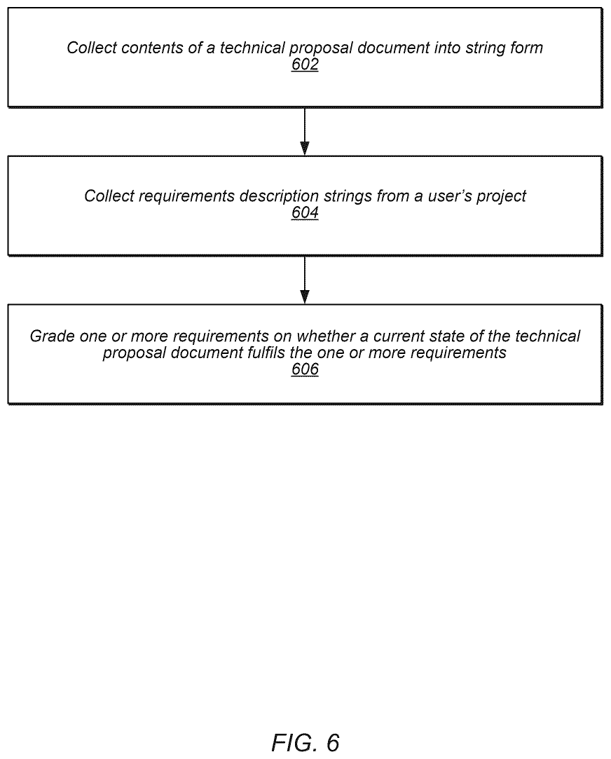

FIG. 6 illustrates a block diagram of an example of a method for artificial intelligence (AI)/Large Language Model (LLM) aided check for compliance of extracted requirements from one or more input documents, according to some embodiments. The method shown in FIG. 6 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 602, content of a technical proposal document can be collected in string form. The string can contain descriptions of all modules a user has selected and inserted in their proposal.

At 604, requirement description strings from the user's project can be collected.

At 606 a prompt can be used to grade one or more requirements on whether a current state of the technical proposal document fulfils the one or more requirements. In some instances, an LLM, such as LLM 304, can be prompted to provide its reasoning as part of its output. This can assist the LLM to work toward a reasonable answer. In some instances, requirement description strings (e.g., two or more) can be packaged into each LLM call to reduce an amount of LLM calls to be issued, as well as to reduce the number of tokens used. In some instances, the LLM requests can then be issued in parallel.

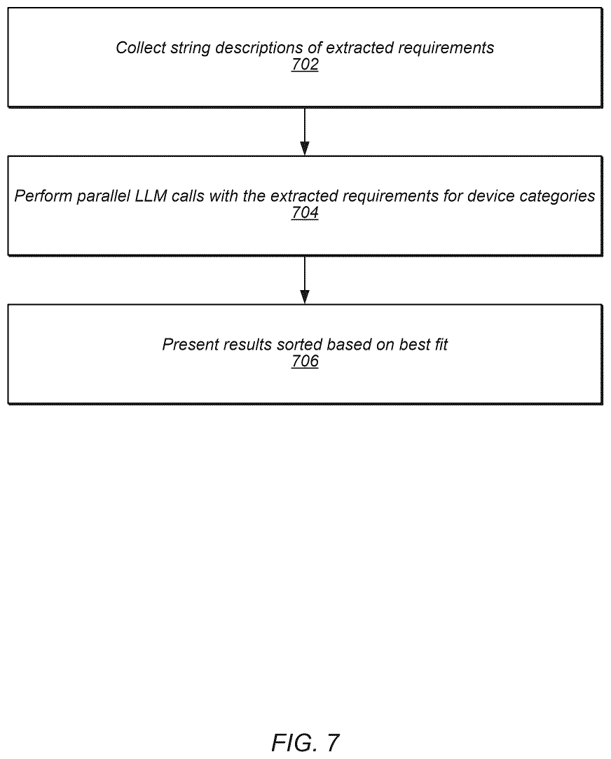

FIG. 7 illustrates a block diagram of an example of a method for artificial intelligence (AI)/Large Language Model (LLM) aided association of extracted requirements from one or more input documents with a device category, according to some embodiments. The method shown in FIG. 7 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 702, string descriptions of selected requirements (e.g., extracted requirements) as well as the names and descriptions of each device category can be collected.

At 704, parallel LLM calls, e.g., of an LLM such as LLM 304, with the selected requirements can be issued for each of the device categories using a corresponding prompt. The prompt can ask the LLM to grade (e.g., very poor fit, poor fit, good fit, very good fit, or unknown) the device category on how well it will meet the requirements based on its description. In some instances, the LLM can be prompted to provide its reasoning as part of its output, which assists the LLM to work its way to a reasonable answer.

At 706, results can be formatted in a pandas data frame sort based on best fit and returned.

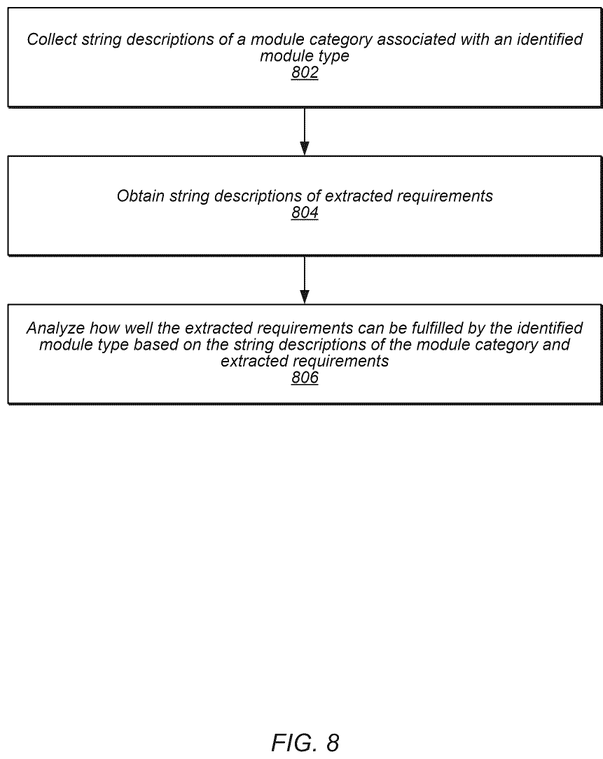

FIG. 8 illustrates a block diagram of an example of a method for artificial intelligence (AI)/Large Language Model (LLM) aided association of device category descriptors to extracted requirements, according to some embodiments. The method shown in FIG. 8 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 802, once a module type is identified and extracted requirements which are likely to apply/be fulfilled by a module of this type are encountered, a string description of a module (or device) category associated with the module (or device) type can be obtained in addition to obtaining the string description of an example module within that module category.

At 804, description strings of extracted requirements in a user's project can be obtained.

At 806, a corresponding prompt may be used to grade (e.g., very poor fit, poor fit, good fit, very good fit, or unknown) and provide a logical analysis of how well the given requirements can be fulfilled by a module of this type. In some instances, the LLM can be prompted to provide its reasoning as part of its output, which assists the LLM to work its way to a reasonable answer. In some instances, requirement description strings (e.g., two or more) can be packaged into each LLM call to reduce an amount of LLM calls to be issued, as well as to reduce the number of tokens used. In some instances, the LLM requests can be issued in parallel. Further, in some instances, results can be filtered to return requirements which have a good or very good fit, and the filtered results can be returned to the user.

In some instances, an AI/LLM program/application used in generating a test system specification from a request for quote/information input file can include a user experience (UX) that includes various UX tools. For example, once logged into the program/application, a UX can include a list of all projects that have been previously created, e.g. in a menu box or dropdown menu. In some instances, the menu box can include UX tools to load a saved project or to create a new project. In some instances, the UX can include a toggle to allow a user to select an LLM and/or a version of an LLM. Further, in some instances, the UX can include a button to upload RFQ/RFI documents (e.g., one or more input documents). As previously noted, these RFQ/FRI documents can be a text document of any a variety of forms. In some instances, the UX can include various interface control icons that allows RFQ/RFI documents to viewed in different manners, allows an RFQ/RFI document to be selected to a project and/or deleted from a project, allows an RFQ/RFI document to be summarized, and/or allows an RFQ/RFI document to be translated into a selected language. In some instances, upon generation of a summary of an RFQ/RFI document, the UX can present a dialog/chat box to allow user interaction and questioning regarding the summary. In some instances, the UX can also present a list of common questions.

In some instances, an AI/LLM program/application used in generating a test system specification from a request for quote/information input file can include hallucination detection to check factuality of generated responses against a set of references. In some instances, the UX can include a toggle-able action to enable/disable hallucination detection. Once run, the UX can present various classifications for claims (e.g., attributable, contradictory, or extrapolatory) that can be highlighted in different colors for easy identification.

In some instances, the UX can include separate threads for each user project. Each thread can have its own chat history which can be provided as context for subsequent language model calls within that thread. Note that when a new or existing project is loaded, a ‘Current Thread’ can be the default selection and a new thread can be created by clicking a ‘New Thread’ button at the top left of a Threads pane presented in the UX

In some instances, the UX can include a “Requirements” pane. The ‘Requirements’ Pane can be accessed by clicking a tab adjacent to a Threads tab, at least in some instances. The Requirements pane cane include a ‘Generate Requirements’ button to allow a user to extract requirements from a project's RFQ/RFIs. Note that the requirements extraction is not a blocking action and more requirements can be generated when more RFQ/RFIs are added to the project. In some instances, the UX can include functionality to allow the requirements to be downloaded as a CSV file. The CSV file can feature ‘|’ as a separator. In some instances, the UX can include a drop down menu for each requirement which allows for categorizing the requirement as Accepted, Rejected, or Undecided. Requirements marked as Rejected can be hidden from the user. Accepted and Undecided requirements can be available for consideration when selecting modules. Requirements can be selected by selecting all ‘All’ check box, selecting individual check boxes per requirement, or filtering by requirement title. With selected requirements, a user can check whether the current state of the proposal/selected modules fulfil the selected requirements by clicking a ‘Requirements Compliance’ button included in the UX. Again, this is not a blocking action and the selected requirements can be inserted into a proposal by clicking an ‘Insert Requirements into proposal’ button included in the UX.

In some instances, the UX can include an architecture tab. Via the architecture tab, a user can select module categories that the user decides should be present in an architecture solution, e.g., via a list of available selections presented to the user. The UX can also reveal requirements that can potentially be fulfilled with the associated module category. The user can evaluate whether a requirement-module enumeration is valid. Again, each requirement can have a drop-down menu where a user can select ‘Accepted’, ‘Rejected’, or ‘Undecided’. The user can then, via the UX, produce a ranked list of specific module instances within that category that best fit the selected requirement.

In some instances, the UX can include access to module categories, e.g., via a modules pane. Module categories which have ‘Accepted’ module selections can appear in green text, while unfulfilled module categories can appear in red text, for ease of identification. Via the modules pane, the use can add module categories, e.g., to fulfil the request set forth in the RFQ/RFI document.

In some instances, the UX can include additional panes. For example, the UX can include a pane for creating a proposal with the help of the LLM.

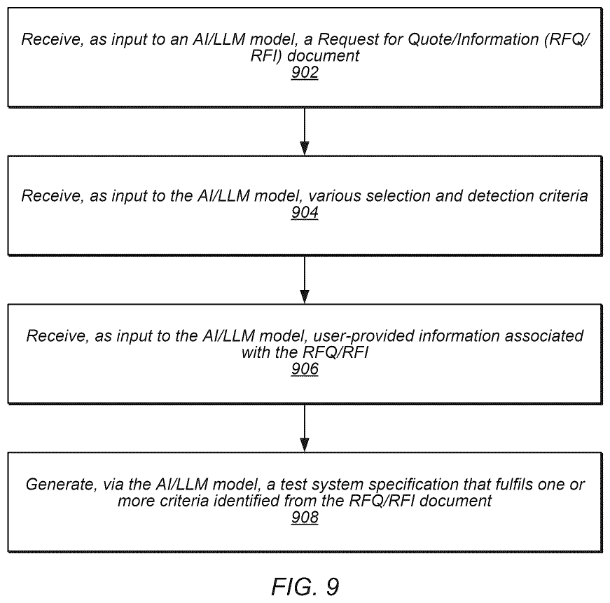

FIG. 9 illustrates a block diagram of an example of a method for artificial intelligence (AI)/Large Language Model (LLM) aided test system specification development, according to some embodiments. The method shown in FIG. 5 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 902, a request for quote/information (RFQ/RFI) document may be received as input to an AI/LLM model, such as AI/LLM model 304. The RFQ/RFI document may be received via a user interface. The user interface may be chat box based, and it may be a locally running application/program or a web-based application/program, among others. Further, the RFQ/RFI document may include various request or queries regarding test system or systems pertaining to testing any one or more devices, systems, or processes. It may further include descriptions or criteria pertaining to these test systems, and any and all information deemed relevant to pursued test systems.

At 904, various selection and detection criteria may be received as input to the AI/LLM model. In some instances, these criteria may include information that provides guidance to the AI/LLM model in extracting pertinent information from the RFQ/RFI document and aiding in generating a test system specification based on the content of the RFQ/RFI document.

At 906, the AI/LLM model may further receive user-provided information associated with the request set out in the RFQ/RFI. The user information may further fine tune and aid the AI/LLM in extracting pertinent information from the RFQ/RFI document and in generating a test system specification based on the content of the RFQ/RFI document.

At 908, a test system specification may be generated, via the AI/LLM model. The test system specification can be targeted to at least partially fulfil one or more criteria included in the RFQ/RFI document and/or provided via user input to the AI/LLM model.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a computer system 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for artificial intelligence (AI)/Large Language Model (LLM) model aided test system specification development, comprising:
receiving, as input to an AI/LLM model, a request for quote (RFQ) document;
receiving, as input to the AI/LLM model, selection and detection criteria;
receiving, as input to the AI/LLM model, user-provided information associated with the RFQ document; and
generating, via the AI/LLM model, a test system specification, wherein the test system specification fulfils one or more criteria identified from the RFQ document.

2. The method of claim 1,
wherein a user interface associated with the AI/LLM model comprises a chat box user interface.

3. The method of claim 2,
wherein the user interface is a locally running application or locally running program.

4. The method of claim 2,
wherein the user interface is a web-based application or a web-based program.

5. The method of claim 1,
wherein the RFQ document includes one or more requests or one or more queries regarding test system or systems pertaining to testing any one or more devices, systems, or processes.

6. The method of claim 5,
wherein the RFQ documents further includes descriptions or criteria pertaining to the test system or systems pertaining to testing any one or more devices, systems, or processes.

7. The method of claim 1,
wherein the detection criteria includes information that provides guidance to the AI/LLM model in extracting pertinent information from the RFQ document.

8. The method of claim 1,
wherein the detection criteria includes information that aids in generating a test system specification based on content of RFQ document.

9. The method of claim 1,
wherein the user-provided information associated with the RFQ document aids the AI/LLM model in extracting pertinent information from the RFQ document and in generating the test system specification based on content of the RFQ document.

10. The method of claim 1,
wherein the test system specification is targeted to at least partially fulfil one or more criteria included in the RFQ document.

11. The method of claim 10,
wherein the test system specification is further targeted to at least partially fulfil one or more criteria provided via user input to the AI/LLM model.

12. A non-transitory computer-readable memory medium storing program instructions which, when executed by a processor, are configured to cause a computing device to perform operations comprising:
receiving, as input to an artificial intelligence (AI)/Large Language Model (LLM) model, a request for quote (RFQ) document;
receiving, as input to the AI/LLM model, selection and detection criteria;
receiving, as input to the AI/LLM model, user-provided information associated with the RFQ document; and
generating, via the AI/LLM model, a test system specification, wherein the test system specification fulfils one or more criteria identified from the RFQ document.

13. The non-transitory computer-readable memory medium of claim 12,
wherein a user interface associated with the AI/LLM model comprises a chat box user interface.

14. The non-transitory computer-readable memory medium of claim 13,
wherein the user interface is a locally running application or locally running program.

15. The non-transitory computer-readable memory medium of claim 13,
wherein the user interface is a web-based application or a web-based program.

16. The non-transitory computer-readable memory medium of claim 12,
wherein the RFQ document includes one or more requests or one or more queries regarding test system or systems pertaining to testing any one or more devices, systems, or processes and descriptions or criteria pertaining to the test system or systems pertaining to testing any one or more devices, systems, or processes.

17. An apparatus, comprising:
a memory; and
at least one processor in communication with the memory and configured to perform operations comprising:
receiving, as input to an artificial intelligence (AI)/Large Language Model (LLM) model, a request for quote (RFQ) document;
receiving, as input to the AI/LLM model, selection and detection criteria;
receiving, as input to the AI/LLM model, user-provided information associated with the RFQ document; and
generating, via the AI/LLM model, a test system specification, wherein the test system specification fulfils one or more criteria identified from the RFQ document.

18. The apparatus of claim 17,
wherein the detection criteria includes information that provides guidance to the AI/LLM model in extracting pertinent information from the RFQ document and information that aids in generating a test system specification based on content of RFQ document.

19. The apparatus of claim 17,
wherein the user-provided information associated with the RFQ document aids the AI/LLM model in extracting pertinent information from the RFQ document and in generating the test system specification based on content of the RFQ document.

20. The apparatus of claim 17,
wherein the test system specification is targeted to at least partially fulfil one or more criteria included in the RFQ document and to at least partially fulfil one or more criteria provided via user input to the AI/LLM model.
